(19) United States
(12) Patent Application Publication
(10) Pub. No.: US 2006/0287065 A1
(43) Pub. Date: Dec. 21, 2006

(54) Value token dispensing system and method

(75) Inventor: Dieter Gunther, Aarbergen (DE)

Correspondence Address: OLIFF & BERRIDGE, PLC, P.O. BOX 19928, ALEXANDRIA, VA, 22320, US

(73) Assignee: DE LA RUE INTERNATIONAL, LTD., Basingstoke (GB)

(21) Appl. No.: 11/152,334

(22) Filed: Jun. 15, 2005

(51) Int. Cl. G06F 17/00

(52) U.S. Cl. 463/25

(57) ABSTRACT

A value token dispensing system comprising a value token dispenser for securely storing value tokens and for dispensing value tokens to a customer in response to a dispense command; a control system for issuing dispense commands when validly authorised to do so; and an input system for inputting a quantity or value of value tokens to be dispensed and including a validation system which enables a dispense command to be issued by the control system when authorised by a supervisor supplying secure data which has been read and validated by the validation system.

### FIELD OF THE INVENTION

The invention relates to a value token dispensing system and a method for dispensing value tokens such as banknotes, ID cards, credit cards and the like.

### DESCRIPTION OF THE PRIOR ART

The automated dispensing of banknotes is very well known and, for example, in automated teller machines (ATMs) a customer presents a bank card or the like together with a PIN which is then authorised and the ATM will dispense a required amount of cash.

For other value tokens such as foreign banknotes, coins and the like and high value quantities of value tokens, conventional ATMs are not used and the customer must attend at a bank. Here, it is usual for a bank teller to operate a teller cash dispenser or teller cash recycler (in the case of banknotes) to dispense value tokens, once the customer has been authorised. Again, authorisation of the customer is typically through use of a PIN or the like.

Recent legislation in some countries now requires that two people are involved in certain transactions. Typically, the teller will check with a supervisor that he (the teller) is authorised to carry out a dispense operation. The problem at present is that there is little security involved and there is a need to improve the security of such authorised transactions.

It is also important in some circumstances to validate the supervisor and this can be a problem particularly in small banks, for example, where limited personnel are available and it is uneconomic to employ two tellers who are on duty at the same time. In addition, if a single teller is on duty and requires a supervisor then someone must be called from a back office to provide authorisation, which is time consuming.

There is a need, therefore, to provide a simple authorising system which enables a transaction to be authorised without significantly disrupting the work of the authorisers.

### SUMMARY OF THE INVENTION

In accordance with a first aspect of the present invention, a value token dispensing system comprises a value token dispenser for securely storing value tokens and for dispensing value tokens to a customer in response to a dispense command; a control system for issuing dispense commands when validly authorised to do so; and an input system for inputting a quantity or value of value tokens to be dispensed and including a supervisor recording system for recording the identity of a supervisor of a dispense transaction and thereafter enabling the control system to issue a dispense command.

In accordance with a second aspect of the present invention, a method of controlling the dispensing of value tokens from a value token dispenser comprises obtaining authority to dispense a required quantity or value of value tokens from a supervisor, and recording the identity of the supervisor.

We have appreciated that a significant increase in security can be achieved by recording the identity of the supervisor. This will normally be done electronically and in association with other transaction details such as customer ID, teller ID, date and amount. This enables the identity of the supervisor of the transaction to be reviewed at a later date and will satisfy new legislation. This could be done manually by the supervisor or a teller, for example, entering details of the supervisor into a store or could be carried out automatically using a validation system or the like, typically of the type described in more detail below.

In some cases, value tokens could be dispensed directly to the customer without the need for a teller. However, the invention is particularly suitable for situations in which a teller at least oversees operation of the value token dispenser and, in some cases, controls the input of information to the dispenser and the subsequent distribution of value tokens. In these cases, the validation system is preferably adapted to read and validate secure data identifying the teller so that value tokens are only dispensed if a teller is present.

In accordance with a third aspect of the present invention, a value token dispensing system comprises a value token dispenser for securely storing value tokens and for dispensing value tokens to a customer in response to a dispense command; a control system for issuing dispense commands when validly authorised to do so; and an input system for inputting a quantity or value of value tokens to be dispensed and including a validation system which enables a dispense command to be issued by the control system when authorised by a supervisor supplying secure data which has been read and validated by the validation system.

In accordance with a fourth aspect of the present invention, a method of controlling the dispensing of value tokens from a value token dispenser comprises validating the identity of the customer, obtaining and validating secure data from a supervisor to authorise a transaction and, if validated, dispensing a required quantity or value of value tokens.

The advantage of systems according to the third aspect of the invention is that the secure data is validated automatically by the validation system thus simplifying the validation process and increasing security over manual validation techniques

In accordance with the fourth aspect of the invention, we envisage the possibility that the validation step could be carried out manually while in either case, it may not always be necessary to record the identity of the supervisor.

As in the previous aspects, the customer could operate the value token dispenser but preferably the operation of the dispenser is at least overseen by a teller, the method further comprising reading and validating secure data identifying the teller, whereby value tokens are only dispense if a teller is present.

A teller will generally be a person who has been specifically authorised to oversee and/or operate the value token dispenser to add to the security of the overall system.

The presence of a teller is particularly useful when the value token dispenser is a teller assist dispenser or the like or a secure container which has to be unlocked to provide access to value tokens stored in the container and from which a number of value tokens are extracted (while leaving others in the container).

Where a teller is used, the supervisor need not necessarily be made aware of the specifics of the transaction he is authorising, the regulations being satisfied by the fact that a supervisor is aware of the transaction and monitoring overall operation of the system.

Typically, the secure data will comprise a PIN or other password but in a particularly preferred approach, the secure data comprises biometric characteristics of the supervisor (and teller), the validation system including a biometric reading system for reading the biometric characteristics.

Conveniently, the biometric reading system comprises two biometric readers. This enables the biometric characteristics of the teller and supervisor to be read in different locations and/or simultaneously, which is particularly advantageous if it is necessary for simultaneous presence of the teller and supervisor to occur in order to authorise the transaction. In less rigorous cases, a single reader could be provided for the supervisor and/or teller. It should be understood that more than one method for inputting security data could be provided. For example, a biometric reader could be provided for the supervisor and a keypad or the like for the teller

In the most preferred embodiments, the biometric characteristic comprises a fingerprint (including nail) or set of fingerprints of the authoriser but other biometric characteristics such as an eye pattern, signature recognition (including shape, speed, pressure), palm print, hand (including knuckle, vascular), facial image or voice and the like could be used.

the use of a biometric reading system can significantly simplify and thus speed up the operation of the system and reduces the risk of fraud. This is particularly convenient in the case of small facilities such as small banks, as explained above, since the supervisor can very easily and quickly provide his authority without the need to recall a complex PIN or other password.

In some cases, depending upon the nature of the transaction and the rules for authorising such a transaction, the supervisor could remain at his desk, possibly in a separate office, in which part of the input system, such as a biometric reading system, is provided.

The supervisor could be within hearing distance of the teller or be able to communicate orally with the teller, e.g. by telephone.

Typically, however, the input system is located such that the supervisor can see (directly or via CCTV) the value token dispenser and/or the teller.

The value token dispenser may be adapted to dispense banknotes, ID cards, credit cards, vouchers, cheques, bank cards, prepayment cards or other security documents and articles.

### BRIEF DESCRIPTION OF THE DRAWINGS

An example of a value token dispensing system in accordance with the invention will now be described with reference to the accompanying drawings, in which:

FIG. 1 is a block diagram of the system; and,

FIG. 2 is a flow diagram illustrating operation of the system shown in FIG. 1.

### DETAILED DESCRIPTION OF THE EMBODIMENTS

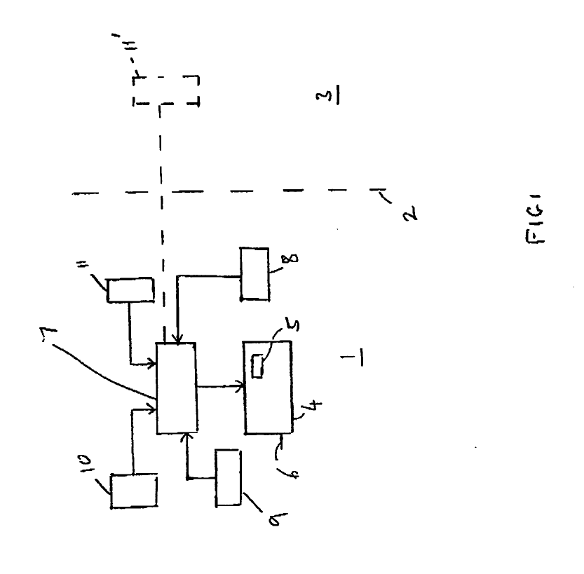

FIG. 1 illustrates schematically the “front office” area 1 of a small bank divided by a wall 2 from a “back office” area 3. A value token dispenser such as a banknote dispenser 4 is located in the front office area 1. The dispenser 4 can be any conventional teller operated dispenser such as a De La Rue Teller Cach Recycler or Teller Cash Dispenser. The dispenser includes a banknote store 5 from which banknotes can be extracted and fed via a transport (not shown) to an outlet tray 6 for collection by a teller who hands the banknotes to a customer. In other cases (not shown), the dispenser may be a locked container from which value tokens can be extracted by a teller in accordance with the requirements of a customer.

The dispenser 4 is controlled by a suitably programmed microprocessor 7 which receives control inputs from a keyboard 8.

The microprocessor 7 is also connected to a card reader 9 and two fingerprint readers, 10, 11.

At the start of his shift, the teller will identify himself to the microprocessor 7. This can be done in a variety of ways by, for example, entering and ID and a password such as a PIN through the keyboard 8 and/or by using the card reader 9. In a particularly preferred approach, the teller provides this secure data using the fingerprint reader 10. Once the teller has been validated by the microprocessor 7, the dispenser 4 can be operated.

In use, a customer who wishes to withdraw cash requests a suitable transaction from the teller. The customer is then instructed to insert an ID card or the like into the card reader 9 and to enter a password such as a PIN via the keyboard 8. Alternatively, he could enter biometric data such as a fingerprint via one of the fingerprint readers 10, 11.

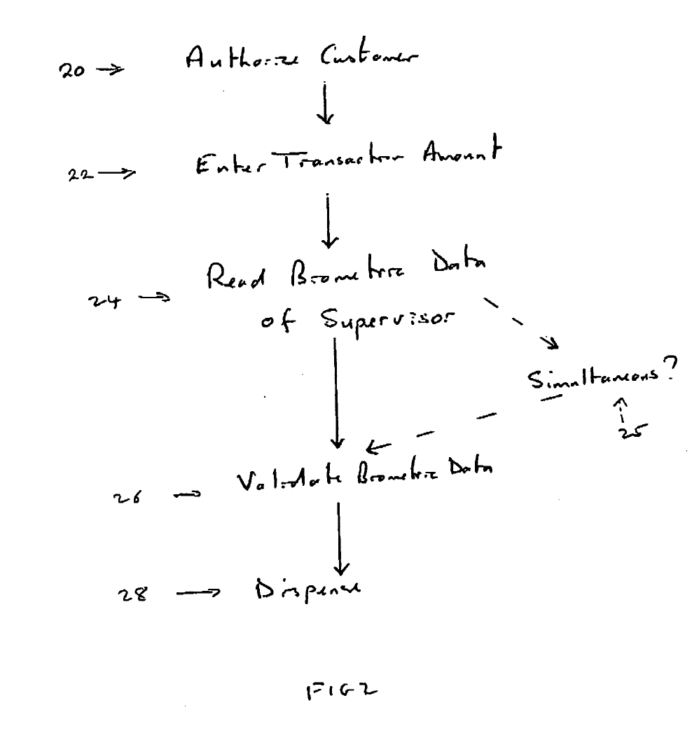

The microprocessor 7 then confirms the identity of the customer in a conventional manner (step 20, FIG. 2), for example by comparing the data input by the customer with valid data stored on the ID card.

The teller then asks the customer to enter the amount of cash he wishes to withdraw, via the keypad 8 (step 22) or alternatively the teller enters the amount

Before the microprocessor 7 will instruct the dispenser 4 to dispense the appropriate number of banknotes, it requires that the transaction is fully authorised. This requires that a supervisor provides fingerprint data via one of the fingerprint readers 10, 11. The teller asks the supervisor, who may be normally located in the back office 3, to walk into the front office and place his finger on the fingerprint reader 11. The biometric data, in this case fingerprint data, is then read and corresponding digital data fed to the microprocessor 7 (step 24).

The microprocessor 7 then validates the fingerprint data (step 26). This can be done in a variety of ways. In the most convenient method, the valid fingerprint data has been previously stored within the microprocessor 7 so that it can carry out immediately a pattern recognition process to confirm that the fingerprint data is valid, i.e. corresponds to a valid supervisor. Alternatively, the supervisor could have the valid fingerprint data on a card which is presented to the card reader 9 at the time of the authorisation and the microprocessor 7 then compares the data obtained from the reader 11 with that from the card.

Assuming that the fingerprint is determined to be valid, then the microprocessor 7 stores data identifying the supervisor, and issues a dispense signal to the dispenser 4 which then dispenses the correct quantity of banknotes from the store 5 to the outlet tray 6 (step 28). The banknotes are then given to the customer by the teller.

In some cases, additional security is achieved by requiring that the two authorisers present their fingerprints on the readers 10, 11 simultaneously. This can be done, for example, by requiring that the fingerprint data is provided within a certain time window and to achieve this the microprocessor 7 can issue a suitable command (audible or visual), for example on a display device such as a monitor (not shown). The method will thus include an additional step 25 prior to carrying out the validation step 26, namely to determine that the two sets of fingerprint data were obtained simultaneously. In a further alternative (not shown), a single fingerprint reader only may be provided with the two authorisers providing their fingerprints sequentially. In this case, some additional security could be achieved if the two fingerprints are required to be presented within a certain short time of each other, for example less than 30 seconds.

In some further applications, the fingerprint reader 11 could be provided in the back office 3 as shown at 11′ in FIG. 1 If a window is provided in the wall 2, or there is a video link, this will enable the supervisor to see the teller while presenting his fingerprint. Such a video (or audio) link would also allow the supervisor to be far further from the teller, e.g. in a different building or even country. In some less secure situations, the wall 2 could be solid and the supervisor simply responds to a request (oral, via email etc.) from the teller.

1. A value token dispensing system comprising a value token dispenser for securely storing value tokens and for dispensing value tokens to a customer in response to a dispense command; a control system for issuing dispense commands when validly authorised to do so: and an input system for inputting a quantity or value of value tokens to be dispensed and including a validation system which enables a dispense command to be issued by the control system when authorised by a supervisor supplying secure data which has been read and validated by the validation system.

2. A system according to claim 1, wherein the validation system includes a biometric reading system for reading biometric characteristics of the supervisor.

3. A system according to claim 1, wherein the operation of the dispenser is at least overseen by a teller, the validation system being adapted to read and validate secure data identifying the teller.

4. A system according to claim 3, wherein the validation system includes a biometric reading system for reading biometric characteristics of the teller.

5. A system according to claim 2, wherein the biometric reading system is adapted to read one or more of a fingerprint, eye pattern, palm print, handprint, signature, facial image and voice.

6. A system according to claim 4, wherein the biometric reading system comprises two biometric readers.

7. A system according to claim 1, wherein the input system is located such that the supervisor, in use, can see the value token dispenser.

8. A system according to claim 1, wherein the operation of the dispenser is at least overseen by a teller, and wherein the input system is located such that the supervisor, in use, can see the teller.

9. A system according to claim 1, wherein the validation system validates secure data by comparing it with prestored valid data.

10. A system according to claim 1, wherein the value token dispenser is adapted to dispense one or more of banknotes, ID cards, credit cards, cheques, bank cards and prepayment cards.

11. A system according to claim 1, wherein the value token dispenser includes a normally locked container containing value tokens, the container being unlocked in response to issue of said dispense command.

12. A system according to claim 1, further comprising a store for storing the identity of the supervisor who validated the dispense transaction.

13. A system according to claim 3, further comprising a store for storing the identity of the teller.

14. A method of controlling the dispensing of value tokens to a customer from a value token dispenser, the method comprising validating the identity of the customer, obtaining and validating secure data from a supervisor to authorise a transaction and, if validated, dispensing a required quantity or value of value tokens.

15. A method according to claim 14, wherein the secure data comprises biometric characteristics of the supervisor.

16. A method according to claim 14, wherein the operation of the dispenser is at least overseen by a teller, the method further comprising reading and validating secure data identifying the teller, whereby value tokens are only dispensed if a teller is present.

17. A method according to claim 16, wherein the secure data identifying the teller comprises biometric characteristics of the teller.

18. A method according to claim 15, wherein the biometric characteristics comprise one or more of a fingerprint, eye pattern, palm print, signature, handprint, facial image and voice.

19. A method according to claim 14, wherein validation is achieved by comparing the secure data obtained with prestored data.

20. A method according to claim 14, wherein the operation of the dispenser is at least overseen by a teller, and wherein the step of obtaining secure data is carried out while the supervisor can see the teller.

21. A method according to claim 14, wherein the step of obtaining secure data is carried out while the supervisor can see the value token dispenser.

22. A method according to claim 14, wherein the value tokens comprise one or more of banknotes, ID cards, credit cards, cheques, bank cards and prepayment cards.

23. A method according to claim 14, wherein the validating step is carried out automatically.

24. A method according to claim 14, further comprising recording the identity of the supervisor who authorised the transaction.

25. A method according to claim 16, further comprising recording the identity of the teller.

26. A value token dispensing system comprising a value token dispenser for securely storing value tokens and for dispensing value tokens to a customer in response to a dispense command; a control system for issuing dispense commands when validly authorised to do so; and an input system for inputting a quantity or value of value tokens to be dispensed and including a supervisor recording system for recording the identity of a supervisor of a dispense transaction and thereafter enabling the control system to issue a dispense command.

27. A system according to claim 26, wherein the operation of the dispenser is overseen by a teller, the validation system being adapted to read and validate secure data identifying the teller.

28. A method of controlling the dispensing of value tokens from a value token dispenser to a customer, the method comprising obtaining authority to dispense a required quantity or value of value tokens from a supervisor; and recording the identity of the supervisor.

29. A method according to claim 28, wherein the operation of the dispenser is at least overseen by a teller, the method further comprising reading and validating secure data identifying the teller, whereby value tokens are only dispensed if a teller is present.
